(19) United States
(12) Patent Application Publication
(10) Pub. No.: US 2014/0212959 A1
(43) Pub. Date: Jul. 31, 2014

(54) SPERM QUALITY ASSESSMENT DEVICE

(71) Applicant: NATIONAL TSING HUA UNIVERSITY, Hsin Chu City (TW)

(72) Inventors: Koji Matsuura, Okayama (JP); Cheng-Han Tsai, New Taipei City (TW); Chao-Min Cheng, New Taipei City (TW)

(73) Assignee: NATIONAL TSING HUA UNIVERSITY, Hsin Chu City (TW)

(21) Appl. No.: 13/871,651

(22) Filed: Apr. 26, 2013

(30) Foreign Application Priority Data
Jan. 28, 2013 (TW) 102103212

(51) Int. Cl. G01N 21/78

(52) U.S. Cl. CPC G01N 21/78
USPC 435/288.7

(57) ABSTRACT

A novel sperm quality assessment device includes a main frame and a test pad. The test pad is encircled by the main frame and includes an exposed introductory portion. The test pad has greater hydrophilicity than the main frame, and includes an MTT reagent. Therefore, the activity pattern of the colored motile sperms can be used to estimate sperm quality, such as motility. The present device has the particular advantage of using paper to reduce manufacturing cost, and is also easy to use.

### FIELD OF THE INVENTION

The invention is a biomedical diagnostic device, specifically a device for assessing sperm quality.

### DESCRIPTION OF THE PRIOR ART

In modern society, various factors, such as rising economic competition which results in a hectic lifestyle and worsening environment, have negatively impacted the condition of the human body. One of the most notable effects has been rising male infertility associated with declining sperm quality.

Moreover, in the breeding and livestock industries, to improve animal reproduction in chickens, pigs, cows, sheep or other species, semen analysis is required to improve animal productivity and quality.

The most widespread conventional method of assessing sperm motility is optical observation under a microscope. This method requires positioning a semen sample on a glass slide, followed by visual inspection of sperm concentration and motility. These processes are labor intensive (an individual operator can only analyze one sample at a time), but also require that the operator be trained to gain sufficient knowledge in correct interpretation. A further disadvantage is that the procedure is generally performed in a laboratory.

Given the above, it is desirable to develop an alternative solution for sperm assay characterized by low cost, easy manipulation, and results that require no special training to read.

### SUMMARY OF THE INVENTION

The present invention aims to provide a device for assessing sperm characteristics, such as motility, in a semen sample.

Additionally, the invention presented here aims to offer low cost, simple structure and high accessibility.

Furthermore, the invention aims to be easy to use and require no special training, which makes it suitable for quick diagnoses in the home.

To achieve the above objectives and others, the proposed sperm quality assessment device comprises a main frame and a test pad. The test pad is encircled by the main frame and includes an exposed introductory portion. The test pad has greater hydrophilicity than the main frame, and contains MTT reagent.

A semen sample is loaded at the introductory portion to diffuse in and on the pad such that a chromogenic reaction occurs between motile sperm and MIT reagent, and thus assessment of various sperm status a be performed.

The present design allows sperm quality tests to be performed at home and at any time, and thus the present invention is ideally suited for males who tend to be reluctant to undergo tests in a hospital setting, a trait that inevitably leads to delayed treatment. Moreover, the present invention allows for rapid assessment rather than the lengthy and often trivial process involved in processing by a hospital, including registration and waiting for test results. On the other hand, the present invention also provides an economical and convenient assessment method for application to the breeding and livestock industries. In a simple application of the proposed method, users can obtain a parameter to assess sperm motility using simply a digital came a cell phone installed with a special application or applications.

In an ideal embodiment, the main frame comprises a wax-penetrated portion of paper and the test pad comprises a non-wax-penetrated portion. This configuration can be achieved through the following steps: creating a pattern on a computer; printing the pattern on a filter paper with solid wax; heating to allow the wax to penetrate the paper. The wax-penetrated portion of the filter paper constitutes the main frame while the remainder constitutes the test pad.

In an ideal embodiment, the test pad includes a center circle region and at least one pair of passages, where for each pair, two passages run outwards from the center circle region in opposite directions, and each terminates at an end circle region. All the above circle regions provide application sites for distributing the MTT reagent into the pad, and the end circle regions are used for recognition during image capture and analysis.

The test pad of the present invention may be formed as a cross structure with four passages; alternatively, it may also take the form of an asterisk type structure with eight passages. As for the selection of the test pad dimensions, each passage ideally should have width ranging from 1 to 5 mm, and length ranging from 5 to 10 mm, and the center and end circle regions should have diameters of 2 to 5 mm. The ratio of the test pad thickness to the diameter of the center circle region may be configured to 0.075. In one example, a test pad has the following dimensions: each passage has width 2 mm and length 7 mm, and the center circle and end circle regions all have diameter 3 mm.

### BRIEF DESCRIPTION OF THE DRAWINGS

The following description and accompanying diagrams clarify the objectives and advantages of the present invention:

FIG. 1 shows a plan view of a sperm quality assessment device according to a first embodiment of the present invention;

FIG. 2 is a cross sectional view of the sperm quality assessment device according to the first embodiment of the present invention, taken along line II-II in FIG. 1;

FIG. 3 illustrates the connections between electrical components used to assess sperm motility;

FIG. 4 illustrates the application of a portable electronic device for sperm quality assessment;

FIG. 5 illustrates the relationship between captured coordinates of pixels and grayscale intensities for sperm quality assessment;

FIG. 6 illustrates a first modification of the test pad profile; and

FIG. 7 illustrates a second modification of the test pad profile.

### DESCRIPTION OF THE PREFERRED EMBODIMENT

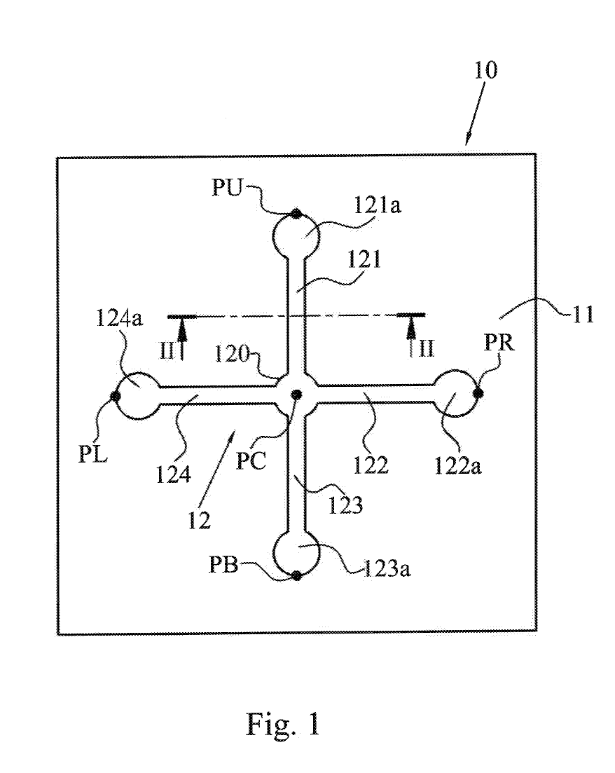

FIG. 1 shows a plan view of a sperm quality assessment device according to a first embodiment of the present invention; in the figure an assessment device 10 basically includes a main frame 11 and a test pad 12 encircled by the main frame 11, and the test pad 12 is partially exposed to the external environment to serve as an introductory portion (such as center circle region 120) for sample entry. Greater hydrophilicity of the test pad 12 versus the main frame 11 is required to set a boundary on motile sperm movement.

In some embodiments, the main frame 11 may be made of a material such as plastic, rubber or the like, and the test pad should preferably be made of paper, such as filter paper sheet. In one embodiment, the assessment device is easily fabricated via wax printing. First, a filter paper sheet is provided, and then a specific pattern for the paper is created using a drawing software installed in a computer. The pattern drawn using the software defines the main frame and the test pad. The pattern is then printed on the paper sheet using wax. Eventually the paper sheet with wax is placed on a heater for heating until wax penetrates through the paper, as illustrated in FIG. 1.

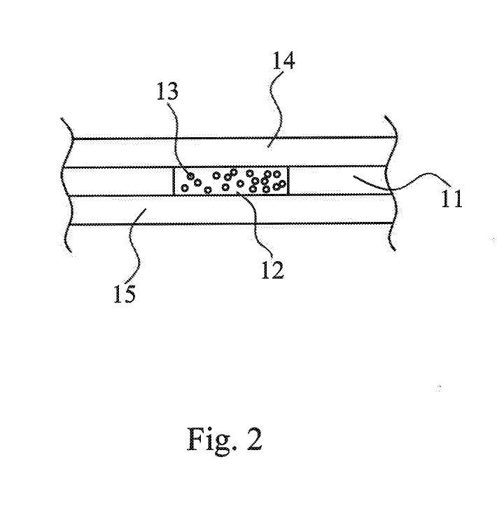

FIG. 2 shows a cross sectional view of the sperm quality assessment device according to the first embodiment of the present invention taken along lines II-II; the figure shows that the assessment device also includes upper and lower covers 14 and 15 for shielding, both of which have smaller hydrophilicity than in the test pad 12 and even the main frame 11. Two covers 14 and 15 sandwich the main frame 11 and the test pad 12. The covers can expose the center circle region 120 to the external environment, thus allowing semen sample entry. For capturing images, the test zone in the test pad must be visible, and this can be achieved by making the portion of the upper cover corresponding to the test pad transparent. Preferably, the upper cover should be entirely transparent.

The test pad 12 includes two pairs of passages, 121 and 123, and 122 and 124. For each pair, two passages run outwards in opposite directions from the center circle region 120. Each passage 121-124 terminates at an end circle region 121a-124a. These four passages are arranged in a cross configuration.

Each passage should have width 1-5 mm and length 5-10 mm, and the center circle region and each end circle region have diameter 2-5 mm. In this embodiment, the width 2 mm and length 7 mm are selected for each passage, and the diameter 3 mm is selected for the center circle and end circle regions. Test pad thickness is selected based on concern about significant diffusing effects, and the ratio of thickness to diameter can be properly adjusted for this effect; for example, the ratio can be set to 0.075 (0.15 mm in thickness and 2 mm in diameter). Dimensional similarity between the center circle and end circle regions does not represent a limitation.

The present also features an MTT reagent [3-(4,5-dimetnyl-thiazol-2-yl)2,5-diphenyl tetrazolium bromide] in the test pad which is yellow and soluble. The MTT reagent can be reduced to purple formazan in motile cells. In preparing a complete test pad, MTT reagent is dispensed in the center circle region 120 or end circle regions 121a-124a.

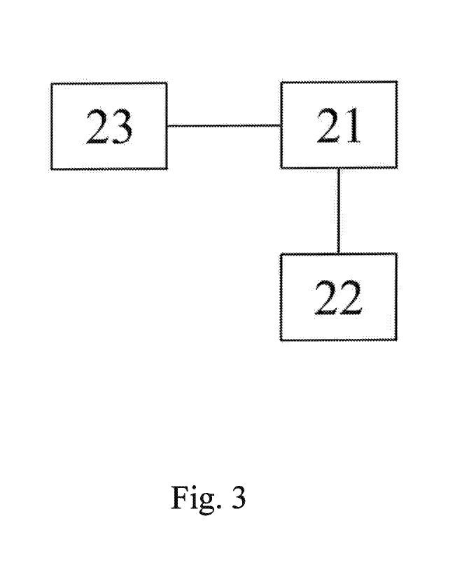

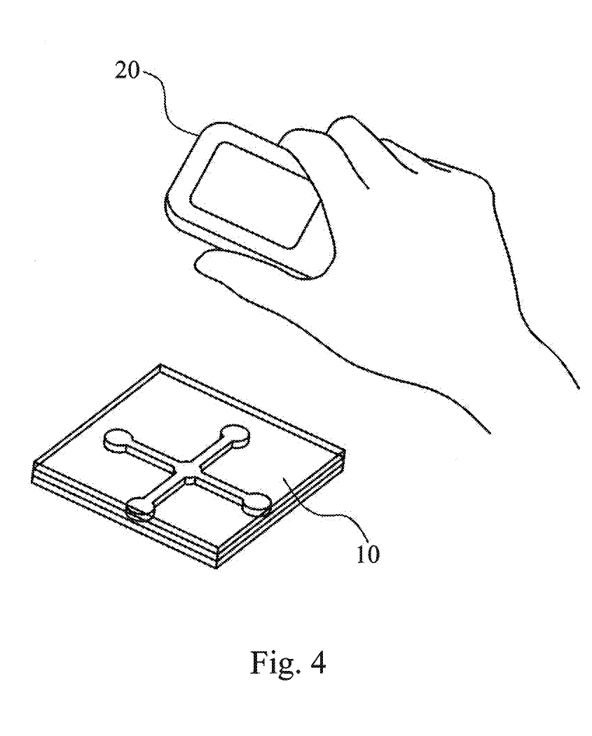

FIG. 3 illustrates the connections between electrical components used with the device in FIG. 1 in sperm motility assessment. FIG. 4 illustrates the use of a portable electronic device integrating the above components. This illustration shows an assessment system for sperm motility that includes the above assessment device and various electronic components, including a processor 21, image capturing module 22, and storage device 23, where the processor 21 is electrically connected with the latter two. The storage device 23 stores applications that allow the processor 21 to execute the following steps. In one preferred embodiment the above electronic components are integrated in a portable electronic device 20, such as a smart phone, a currently popular model, notebook computer, or personal digital assistant, as shown in FIG. 4.

After a semen sample is placed on the device for assessment, motile sperm in the sample displays a specific color upon contacting the MTT reagent during swimming. The resultant color change should be externally visible.

Next, the image capture module is used to capture an image of the assessment device, including the side where the color change occurs. The image captured is then converted into a grayscale, namely the original image is digitally processed into an 8 bit gray scale image.

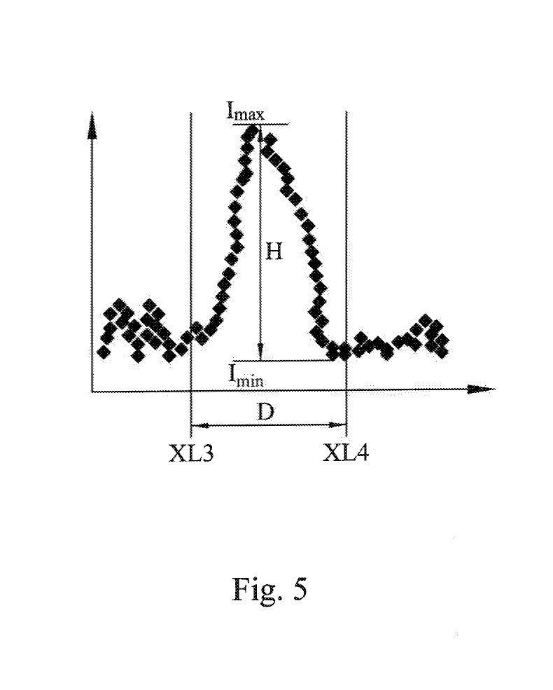

Next, the horizontal and vertical coordinates of the pixels and the grayscale intensities of the corresponding pixels are read out. Coordinates of the edge points of left and right end circle regions 124a and 122a shown in FIG. 1 are first extracted, and are expressed by PL(XL1,YL1) and PR(XL2,YL2), respectively. In FIG. 5, the horizontal axis indicates a distribution along a connecting line between points PR and PL in terms of pixel number, and the vertical axis indicates pixel grayscale intensity. The connecting line between points PR and PL coincides with a middle line which bisects the passage width.

Next, diameter D of the circle is calculated by locating the edges of the circle, where D indicates pixel number. Diameter should be the same for all circle regions.

The coordinates of the center of the center circle region are expressed by

$$PC ( \frac{XL 1 + XL 2}{2} , \frac{YL 1 + YL 2}{2} ) ,$$

and thus the coordinates for the left and right edge points of the center circle region, XL3 and XL4, can be determined:

$$XL 3 = \frac{XL 1 + XL 2}{2} - \frac{D}{2}$$

$$XL 4 = \frac{XL 1 + XL 2}{2} + \frac{D}{2}$$

Next, the horizontal and vertical coordinates of pixels within the interval of interest defined by the center circle are extracted. The value of the vertical coordinate that indicates intensity is expressed by I(XL3+i), where i is an integer ranging from 0 to D.

Next, the maximum and minimum intensities (Imax and Imin) within the interval of interest are calculated, and their difference is signal height (H=Imax−Imin).

Next, the sperm motility parameter (M), that follows the line connecting PR and PL and forms a base line for image capture, is calculated.

$$M = {\sum }_{i = 1}^{D} [ {I}_{max} - I ( XL 3 + i ) ] / D$$

Following the same logic, since coordinates of edge points PU and PB of the upper and lower end circle regions 121a and 123a can be extracted, another motility parameter, that follows the connecting line between PU and PB and is used as the base line for image capture, can be determined by implementing the above steps.

The final result is the average of these two motility parameters.

The manufacturer is expected to provide a comparison table so that users can recognize the meaning of calculated M by comparing the calculated parameters of samples whose motility has already been analyzed using another method.

The above indicates that the present assessment device not only achieves low-cost fabrication but also enables the public to test sperm motility independently without professional training. This device has a notable advantage over prior art in that assessment can be done simply with a camera phone. This device thus considerably reduces incorrect results ascribable to manual inspection error.

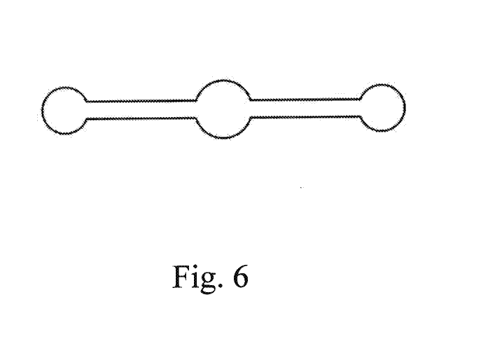

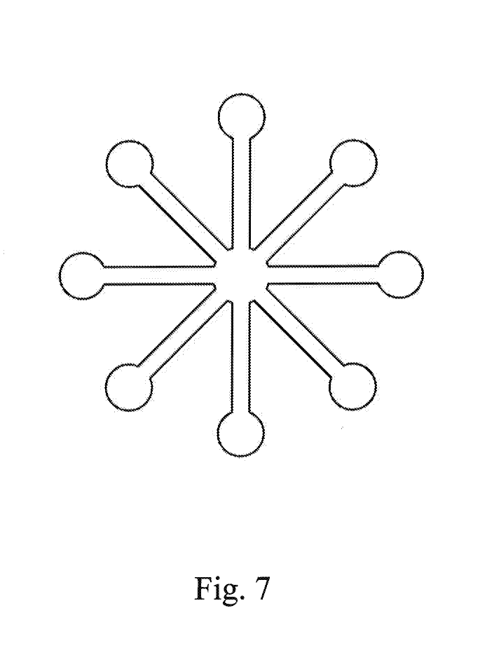

FIGS. 6 and 7 show the first and second modifications of the test pad profile. The test pad of the present invention is not limited to the example of the above cross structure, and a test pad with a different number of passage pairs may be an alternative. For example, FIG. 6 illustrates a test pad that includes only one pair of passages and FIG. 7 shows a tour-pair version.

Though the process described uses electrical components integrated in a single portable electronic device, separate components can also be utilized. For example, the image capturing module may be a webcam, and the processor and storage device in the form of a hard drive are included in a desktop computer connected to the web cam and a display.

What is claimed is:

1. A sperm quality assessment device, comprising:
a main frame; and
a test pad encircled by the main frame and including an exposed introductory portion;
wherein hydrophilicity of the test pad is greater than that of the main frame and MTT reagent is distributed in the test pad therein.

2. The sperm quality assessment device of claim 1, wherein the main frame refers to a wax-penetrated portion of a paper sheet and the test pad refers to a non-wax-penetrated portion of the paper sheet.

3. The sperm quality assessment device of claim 1, wherein the test pad includes a center circle region and at least one pair of passages, where for each pair the passages run outwardly from the center circle region in opposite direction and each passage terminates at an end circle region.

4. The sperm quality assessment device of claim 3, wherein the test pad is shaped to be crossed.

5. The sperm quality assessment device of claim 3, wherein the test pad is shaped as an asterisk.

6. The sperm quality assessment device of claim 3, wherein each passage has a width of 1-5 mm.

7. The sperm quality assessment device of claim 3, wherein each passage has a length of 5-10 mm.

8. The sperm quality assessment device of claim 3, wherein each of the center circle region and the end circle regions has a diameter of 2-5 mm.

9. The sperm quality assessment device of claim 3, wherein a ratio of a thickness of the test pad to a diameter of the center circle region is 0.075.

10. The sperm quality assessment device of claim 3, wherein each passage has a width of 2 mm and a length of 7 mm, and each of the center circle region and the end circle regions has a diameter of 3 mm.
